(19) United States
(12) Patent Application Publication
(10) Pub. No.: US 2008/0127136 A1
(43) Pub. Date: May 29, 2008

(54) Software build system, software build method, and recording medium storing software build program

(75) Inventors: Katsushige Hino, Kawasaki (JP); Nobuyuki Miyazaki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/899,344

(22) Filed: Sep. 5, 2007

Related U.S. Application Data
(63) Continuation of application No. PCT/JP05/04254, filed on Mar. 10, 2005.

(51) Int. Cl. G06F 9/45

(52) U.S. Cl. 717/140

(57) ABSTRACT

A software build system includes a software build device, a material storage, and a terminal. When a material ID of a software material is designated by the terminal, a software builder establishes an internal work area and activates an Ant execution system. The Ant execution system performs a software build process using a source program and the like according to an Ant definition entity. A software composite material that is obtained as a result of the material build by the Ant execution system is stored in the internal work area. The software builder refers to a software-material configuration-definition entity, and writes back into the material storage, the software composite material present in the internal work area.

This is a continuation filed under 35 U.S.C. § 111(a), of International Application No. PCT/JP2005/004254, filed Mar. 10, 2005.

### BACKGROUND OF THE INVENTION

1. Field of the Invention

The present invention relates to a software build system, a software build method, and a recording medium that stores a software build program.

2. Description of the Related Art

Generally, in software development, a software product is manufactured by the following two procedures.

(1) Programming: Programmers write respective source programs.

(2) Build: The compilation and linking of the source programs, as well as various combining processes. Of course, the programming at (1) is the key in software development. However, with software development becoming more and more complicated and larger in scale recently, the importance of software build (building) at (2) is increasing. The present invention is to be employed in the process of (2) build.

Generally, the process of creating a composite by combining elements is common to industries including those other than software development. However, in the case of software, there are specific problems such as those listed from (a) to (e) below.

(a) A large number of source programs (elements) are involved in building. It is not unusual for one software product to be created by the building and linking of 5000 to 10000 source programs written by programmers.

(b) These source programs further have a large number of versions (usually, several dozen to several hundred), which results from the ease of changing software and source programs, usually being updated gradually to correct a bug or to extend capabilities.

(c) Configuration relation (combination relation) is multistage-multilayer.

(d) There are diverse ways of combining elements. The simplest ways include copy and compilation. However, in addition to these methods, there are a wide variety of software specific combinations such as link editing, combining to the installation format, combining to a specific format for each platform, and extraction of only a modified part.

(e) Software products are normally provided to customers in many versions in parallel, a cause of the increasing complexity of software building. If a software build system that overcomes these problems is realized, a half (the remaining half is programming) of credibility in software development would be significantly improved.

Because of the variety and complexity specific to software building listed as the above (a) to (e), software building by hand is almost impossible. In the software industry, it is already recommended to use a software build system (hereinafter, “software build system”) to automate the building, and actually, a software build system of some kind is normally introduced to a usual development team.

A conventional software build system has the following functions (f) to (k) below.

(f) Material storage: A source program group is stored in a certain database, and programmers can refer to and update the source program group.

(g) Version management: When a source program is updated, the source program is stored as a new version. A history of the changes is also managed. Comparison of changed parts between versions is also possible (there is a software build system in which the changed parts can be visually compared).

(h) Version branching management: In a version system, not only simple sequential change but also branching is allowed, and a different line of versions from the mainstream can be created and managed. By this means, a version that is corrected specially for a specific customer and the like can also be managed.

(i) Simultaneous update control: It is possible to correct in advance or after the occurrence of a discordance that is caused by the updating of the same program simultaneously by more than one programmer.

(j) Baseline management: Source programs can be stored specifying a product version in which each revision group of each source program is to be included enabling extraction of a set of source programs to be included in a specific product version, and input to a build tool.

(k) Distribution management: There also is a software build system that can arrange the database in which source programs are stored, in a geographically distributed manner.

Currently, an integrator (software builder) manages source programs with a software build system that has functions such as the above (f) to (k), and defines a composite method (defining what materials are used as elements and in what relation a software product is configured) of a product to be provided to customers with Makefile language or Ant language, thereby automating the software build processes.

Moreover, as conventional software build systems, a system that facilitates link and combination between systems under different environments by combining existing software components (for example, Japanese Patent Laid-Open Publication No. 2002-358199) and a system with which a control logic and source programs that define the control logic can be grasped (for example, Japanese Patent Laid-Open Publication No. 2000-089945) are disclosed.

As described above, the conventional software build systems systemize a certain range of the software build processes. However, when a software build process is large-scale and regarded to be composed of phases (I) to (III) below, in the conventional software build systems, only material management (pre-build) of phase (I) among all phases is systemized as described above. The functions of the conventional software build systems listed as (f) to (k) also belong to the material management (pre-build) of phase (I).

(I) Material management (pre-build): Constituent elements (source programs) are properly identified.

(II) Build: Compose the constituent elements by a proper composite method.

(III) Material management (post-build): The composed materials are also properly kept.

However, phases (II) and (III) are not systemized. Although Makefile language and Ant language are, of course, to automate the build procedures, automation is possible only if programmed as such, similar to ordinary programs, and therefore, the build procedures are not integrated and systemized having an organic link with the material management (pre-build) of phase (I) in the software build system. “Not systemized” herein indicates the phenomena described as the following (l) to (n).

(l) A configuration description method of Makefile language and Ant language is not standardized (there is a large possibility that each programmer can write the same thing in a different way). In this regard, there is no difference from ordinary programs and leads to disadvantages as in the following (l-1) to (l-3) in terms of credibility.

(l-1) Descriptability and readability of a configuration definition are not sufficient.

(l-2) Program errors are likely to be included.

(l-3) It is difficult to refer to and use the configuration definition itself as configuration definition “data” (for example, automatic detection of errors in use relation of parts).

(m) Execution of the configuration definition entity thus described is required to be done (can be done) manually, independently of the software build system. For example, settings of an input group before execution of the configuration definition entity and identification and custody of output materials after execution are handled manually.

(n) Further, until the final product to be provided to customers is completed, operations of (n-1) converting into an installation format and of (n-2) extracting only a modified part are required. For these operations, another tool and script must be created and there is a lot of manual intervention, and thus, is never achieved by a single command at once.

If optimistically viewed, the above (l) to (k) can be regarded as (l′) a configuration definition is performed using Makefile language or Ant language, (m′) building is automated thereby, and (n′) product creation is automated by a tool or a script. Therefore, it is often evaluated that automation is advanced compared to a build method to which even such arrangements are still not applied.

However, when such operations are further specifically viewed, there is manual intervention between respective operations as described above. Since only a slight procedural error can ruin the credibility of the entire operations of a software build process, automation of this level still leaves a great deal of concern.

In short, regarding conventional software build systems, phase (I) among phases (I) to (III) in the software build processes is systemized, but phases (II) and (III) are not systemized yet and require human intelligence and manual intervention. In fact, there is a great chance that various errors as listed below may occur.

Specifically, there has been a problem in that there is confusion since just collecting a set of source programs is a lot of work because which version of what source program is available in what location is not known. Moreover, there has been a problem in that even when one offering is corrected and the same correction should be reflected in another offering, correction of the other offering is forgotten. Furthermore, there has been a problem in that since a source program is enormous, a partial modification of the overall configuration is not noticed.

There has also been a problem in that a failure for which a press release has been issued stating that the failure is to be corrected is forgotten to be corrected. Moreover, there has been a problem in that since there is no guaranteed that an offering can be re-produced such that the offering is the same as a previously produced offering, integration operation is difficult to be taken over by a different person. Further, there has been a problem in that an error is caused in the integration of components and parts of another product.

### SUMMARY OF THE INVENTION

It is an object of the present invention to at least solve the above problems in the conventional technologies.

A computer-readable recording medium according to one aspect of the present invention stores therein a software build program that causes a computer to execute receiving a designation of a first identification information indicative of an output material that is a composite of a plurality of input materials; identifying, based on a configuration-definition entity, a second identification information indicative of each of the input materials, and a third identification information indicative of a composite method of composing the input materials to generate the output material; extracting the input materials from a material storage based on the second identification information; and composing the input materials based on the third identification information.

A software build method according to another aspect of the present invention includes receiving a designation of a first identification information indicative of an output material that is a composite of a plurality of input materials; identifying, based on a configuration-definition entity, a second identification information indicative of each of the input materials, and a third identification information indicative of a composite method of composing the input materials to generate the output material; extracting the input materials from a material storage based on the second identification information; and composing the input materials based on the third identification information.

A software build system according to still another aspect of the present invention includes a storage unit that stores a plurality of input materials and a configuration-definition entity that defines a configuration of an output material that is a composite of the input materials; a receiving unit that receives a designation of a first identification information indicative of the output material; an identifying unit that identifies, based on the configuration-definition entity, a second identification information indicative of each of the input materials, and a third identification information indicative of a composite method of composing the input materials to generate the output material; an extracting unit that extracts the input materials from the storage unit based on the second identification information; and a composing unit that composes the input materials based on the third identification information.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram illustrating a configuration of a software build system according to an embodiment of the present invention;

FIG. 2 is a diagram of a hardware configuration of the software build device according to the embodiment of the present invention;

FIG. 3 is a system diagram illustrating the configuration according to the embodiment of the present invention;

FIG. 4 is a schematic of a standard folder structure according to the embodiment of the present invention;

FIG. 5 is a schematic illustrating a definition of a material;

FIG. 6 is a schematic illustrating a result of combining material definitions;

FIG. 7 is a schematic of an example of a configuration definition;

FIG. 8 is a schematic of the configuration definition shown in FIG. 7;

FIG. 9 is a chart illustrating a data structure of a software-material configuration-definition entity according to the embodiment of the present invention;

FIG. 10 is a chart illustrating relativity between relation and an element;

FIG. 11 is a chart of the D-Param;

FIG. 12 is a schematic of an example of the configuration definition;

FIG. 13 is a schematic illustrating a folder state after a configuration definition is executed in the conventional method;

FIG. 14 is a schematic illustrating a folder state after execution of the configuration definition according to the embodiment of the present invention;

FIG. 15 is a schematic of an example of set;

FIG. 16 is a system configuration diagram of the build system;

FIG. 17 is a schematic illustrating interpretation from the software-material configuration-definition entity to the Ant definition entity;

FIG. 18 is a schematic of a tree configuration of a customer providing material;

FIG. 19 is a schematic illustrating an example of the software-material configuration-definition entity of the customer providing material shown in FIG. 18;

FIG. 20 is a schematic of the Ant definition entity converted from the software-material configuration-definition entity shown in FIG. 19;

FIG. 21 is a flowchart of a software build process performed by the software builder shown in FIG. 16;

FIG. 22 is a block diagram of the software build system according to the embodiment of the present invention; and

FIG. 23 is a flowchart of a software build process by the software build system according to the embodiment of the present invention.

### DETAILED DESCRIPTION OF THE PREFERRED EMBODIMENTS

Referring to the accompanying drawings, exemplary embodiments according to the present invention are explained in detail below.

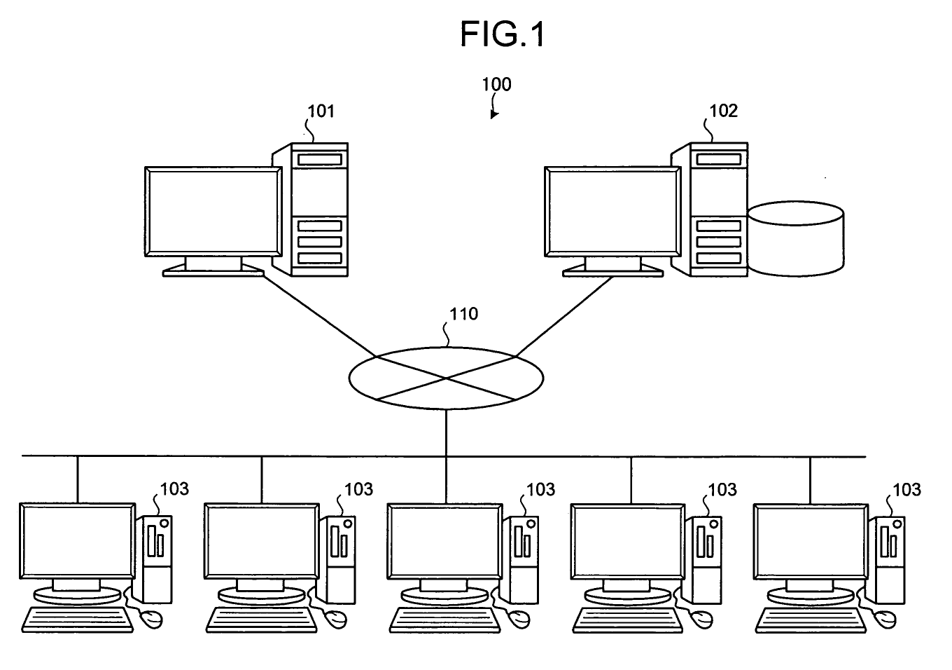

FIG. 1 is a schematic diagram illustrating a configuration of a software build system according to an embodiment of the present invention. In a software build system 100, a software build device 101 to be a managing server, a material storage 102 to be a database server, and terminals 103 are connected in a mutually communicable manner through a network 110 such as a local area network (LAN), a wide area network (WAN), and the internet.

The software build device 101 has a version managing function of source codes that are elements of software and an automatic build function that builds software from the source codes and the configuration definition entity of a software material described later. The material storage 102 stores source codes and configuration definition entities of software materials. The terminals 103 are used by developers and integrators to perform description of source codes and a configuration definition entity of a software material, and provide various instructions or perform calling.

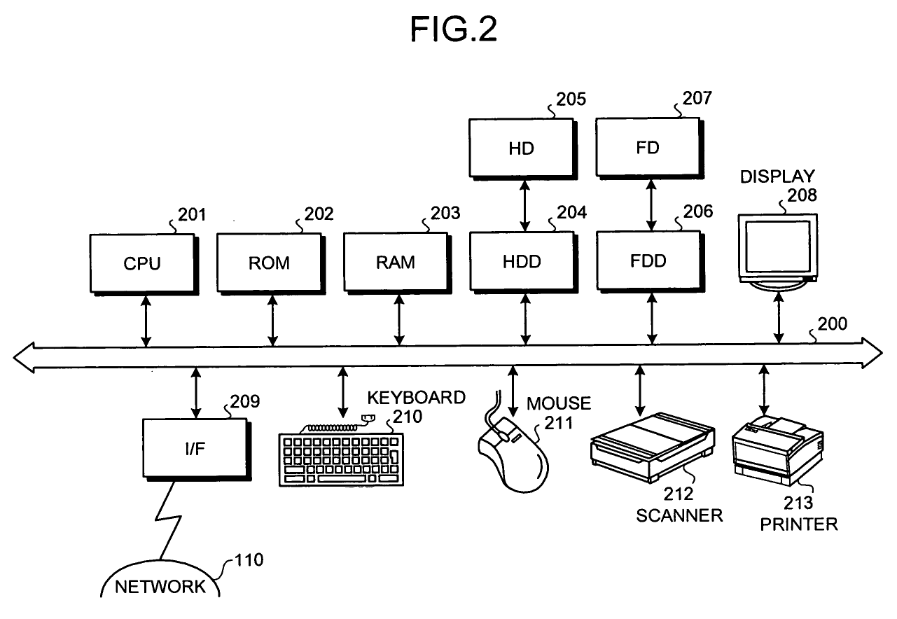

FIG. 2 is a diagram of a hardware configuration of the software build device 101 and the like according to the embodiment of the present invention. As shown in FIG. 2, the software build device 101 and the like include a central processing unit (CPU) 201, a read only memory (ROM) 202, a random access memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, a scanner 212, and a printer 213. Respective components are connected through a bus 200.

The CPU 201 controls the entire software build device 101 and the like. The ROM 202 stores a program such as a boot program. The RAM 203 is used as a work area of the CPU 201. The HDD 204 controls the reading and writing of data with respect to the HD 205 according to the control of the CPU 201. The HD 205 stores data that is written under the control of the HDD 204.

The FDD 206 controls the reading and writing of data with respect to the FD 207 accordance to the control of the CPU 201. The FD 207 stores data that is written under the control of the FDD 206 and allows the software build device 101 and the like to read the data that is stored therein.

As a removable recording medium, besides the FD 207, a compact disk read-only memory (CD-ROM), a compact disk recordable (CD-R), a compact disk rewritable (CD-RW), a magneto optical (MO) disk, a digital versatile disk (DVD), a memory card, or the like can be employed. The display 208 displays a cursor, icons, tool boxes, and data including text, images, and functional information. As the display 208, for example, a cathode ray tube (CRT), a thin-film transistor (TFT) liquid crystal display, a plasma display, or the like can be employed.

The I/F 209 is connected to the network 110, such as the Internet, through a communication line, and is connected to other devices through the network 110. The I/F 209 is the interface between the inside and the network 110, and controls the input and output of data to and from an external device. As the I/F 209, for example, a modem or a LAN adaptor can be employed.

The keyboard 210 has keys to input characters, numerals, various instructions, and the like, and inputs data. A touch panel or a numeric key pad can be used. The mouse 211 performs shift of a cursor, selection of a range, or change of the position and the size of a window. As long as similar functions are provided as a pointing device, a trackball or a joystick can be used instead.

The scanner 212 optically reads an image, and captures image data into the software build device 101 and the like. The scanner 212 can have an optical character recognition (OCR) function. The printer 213 prints image data or text data. As the printer 213, for example, a laser printer or an ink jet printer can be employed.

The material storage 102 has a function of storing software materials (hereinafter, “material”). Similarly to the case of explorer, electronic documents such as a source program and a binary to be provided to customers are stored in folders that are hierarchically arranged. Of course, reference and update of those materials can also be graphically performed.

Ordinary users (developers) perform operations of registering, referring, and updating of the electronic documents (source programs and the like), i.e., the software materials, and for such operations, there are a functions of coordinating simultaneous updates made by more than one person, controlling access authority, updating history, and the like.

The folder hierarchy of the material storage 102 is arranged from the highest in the order of “data storage”, “project”, and “configuration”. The “data storage” is merely a group at one level higher than the project. Furthermore, the “project” corresponds to, for example, a unit such as Interstage Application Server and TeamwareOffice. Each “configuration” corresponds to each version such as version 97 of Interstage Application Server and version 185 of TeamwareOffice.

Among these, the “configuration” is to specify materials that are logically closely related to each other and an appropriate version set, and is the most important unit in managing the software configuration. The “configuration” has a one-to-one correspondence with a “version of a unit of a customer providing material (for example, unit of Interstage Application Server, TeamwareOffice, or the like), and basically, all materials that are used in the version of the providing material are present in the configuration folder.

There is a case in which a material that belongs to another configuration is externally referred. In this case, the material is not necessarily required to be present in the own configuration. Moreover, configurations have a structure similar to a family tree expressing relations, such as parent and child, siblings (in other words, branching), and offspring.

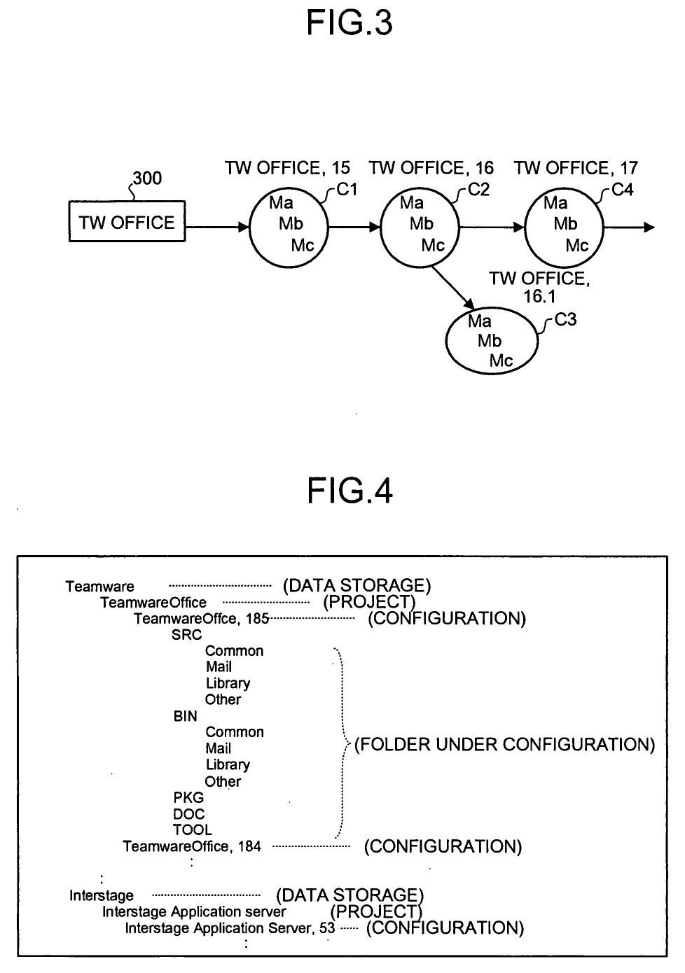

FIG. 3 is a system diagram illustrating the configuration according to the embodiment of the present invention. In FIG. 3, circles represent configurations and arrows represent a parent and child relation of the configurations. For a customer providing material (name of the customer providing material: TW Office) 300, a parent and child relation of configurations C (C1 to C4) is established.

The configuration C has a name of the customer providing material: TW Office to be a material identification (ID). For example, the material ID of the configuration C1 is “TW Office, 15”, the material ID of the configuration C2 is “TW Office, 16”, the material ID of the configuration C3 is “TW Office, 16.1”, and the material ID of the configuration C4 is “TW Office, 17”. Moreover, Ma to Mc in each of the configurations C represent materials M, and numbers at the end (15, 16, 16.1, 17) represent the revision of the materials M.

FIG. 4 is a schematic of a standard folder structure according to the embodiment of the present invention. There is a certain rule also in creation of a folder structure subordinate to the configuration. Specifically, as shown in FIG. 4, right under “TeamwareOffice, 185”, which is a configuration, a folder structure corresponding to types of materials such as SRC (source file), BIN (binary file), PKG (providing material), and DOC (document) is set up.

Furthermore, in the example shown in FIG. 4, the folder is hierarchically arranged in the order of data storage, project, and configuration. In the folders right under the configuration, files with extensions having the corresponding folder name are stored. For example, in the folder SRC, source files of “Common”, “Mail”, “Library”, and “Other” are stored.

“Definition of a configuration of a material” is to define a logic configuration of a software material, in other words, to define how each material is configured, using what material as an element in what relation. As a language to define a material configuration, Makefile language is most frequently used at present, and Ant language is rapidly spreading recently. However, in the present embodiment, an original configuration definition language is prepared.

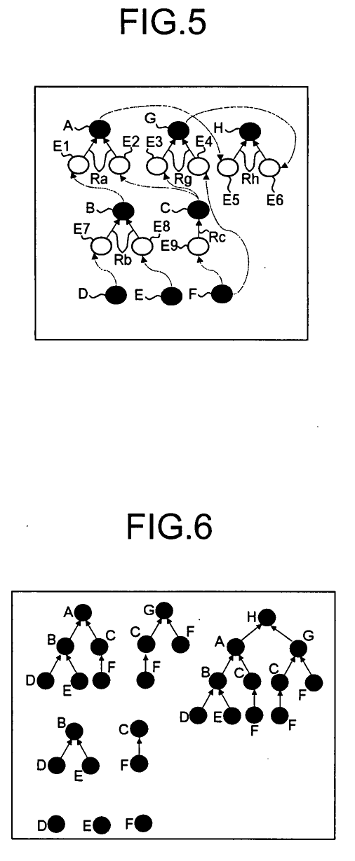

In the configuration definition language, all materials are defined by three concepts of material, relation, and element. For example, a material of a binary code can be defined as configured with elements of a source program in relation of compilation. FIG. 5 is a schematic illustrating a definition of a material. In FIG. 5, A to H represent “materials”, Ra to Rc, Rg, and Rh represent “relation”, and E1 to E9 represent “elements”. For example, the element E1 of the material A is the material B. Moreover, the element E5 of the material H is the material A.

As above, an element of a material is also another material. Therefore, by using respective material definitions as modules, and by combining the modules using the elements as connecting points, a multistage material configuration can be defined, and a multi-headed configuration can also be defined. FIG. 6 is a schematic illustrating a result of combining the material definitions. Because of the property as a module of the material definition, it is possible to additionally define a new superior material not expected at the beginning, or to change the configuration.

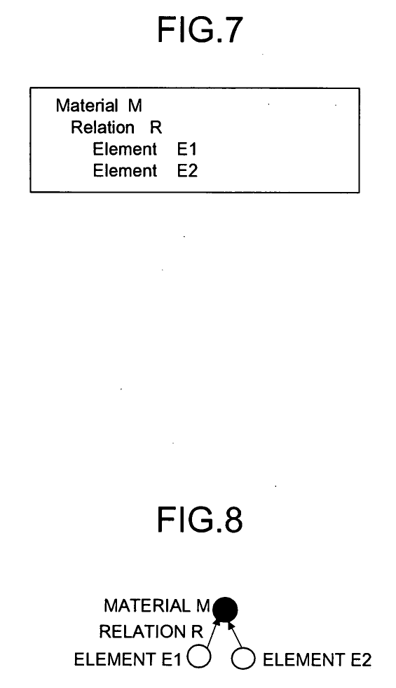

FIG. 7 is a schematic of an example of a configuration definition. FIG. 8 is a schematic of the configuration definition shown in FIG. 7. The configuration definition language is an abstraction oriented declarative language. With the above configuration definition language, the configuration of software is defined by (simple) repetition of material, relation, and element. It is guaranteed that if a material exists, each material always exists as statically defined by the configuration definition (declarativity of a configuration definition language). Users are not required to be careful about how the process execution order is arranged, in what order the process is performed, what happens if the same thing is repeated a plurality of times, and the like. The configuration definition is briefly explained herein.

The configuration definition shown in FIGS. 7 and 8 is read as “the material M has the element E1, the element E2, and relation R”. This single configuration definition is used in different meanings in building and in tracking material use relation. In building, this configuration definition means that “the material M is formed by combining the element E1 and the element E2 by the operation R”, and in tracking material use relation, this configuration definition means that “the material M uses the element E1 and the element E2 in the relation R”. If the material M already exists in building, it also means that “nothing is to be performed”. As described, the abstraction and the declarativity of the configuration definition language enhance readability and flexibility of a configuration definition, and eventually, improve credibility of a configuration management work.

The configuration definition entity of a software material is a set of attribute information of all materials. The set of this attribute information exists in a single file. Herein, the configuration definition entity of an arbitrary material is explained.

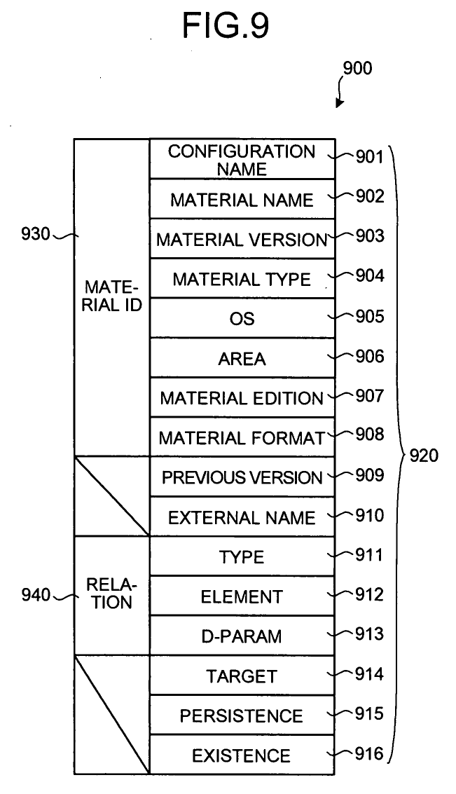

FIG. 9 is a chart for explaining a data structure of a software-material configuration-definition entity according to the embodiment of the present invention. As shown in FIG. 9, a configuration definition entity 900 of a software material is a set of attribute information 920 (910 to 916). The material includes a basic material and a composite material. The basic material is, for example, a source program, and the composite material is, for example, a binary data in an executable format that is created as a result of compiling or editing source programs.

The material is identified by a material ID 930 (a configuration name 901, a material name 902, a material version 903, a material type 904, an operable operating system (OS) 905, an area 906, a material edition 907, and a material format 908). When a new configuration is created, attribute information other than the material version 903, a last version 909, an external name 910, and an existence 916 is carried over as attribute information of the configuration that is newly created.

Among the attribute information 920, the configuration name 901 specifies the configuration to which the material belongs. When omitted, it is regarded as the same as the configuration to which the attribute information 920 belongs. The configuration name 910 is used when the material belongs to a different configuration, for example, when a component belonging to another product is shared or when a common material is installed in many products. A common material group is managed as an independent configuration.

The material name 902 indicates a name of a material, for example, “TWmail002.c” “Istage008.exe”, and the like. The material name 902 is required to be consistent with a file name or a folder name in which contents of the material is included. A slash “/” is used as a separator of folders. The name of a set material coincides with the folder name or a “wildcard that specifies the folder”.

When file names are the same but different as materials, the files are distinguished by modification of a folder name. When the material is not a target material (material to be delivered to customers), the configuration name is regarded as omitted. Therefore, in this case also, the material ID is unique in the build system. In the target material, the material name is usually the same as the configuration name, and therefore, can be omitted. When the material is the target material, the material name 902 is required to coincide with the configuration name 901.

The material version 903 indicates a version of the configuration to which the material belongs. Therefore, respective materials that belong to the same configuration have the same version number. A version part in the name of a configuration should indicate the version number of the configuration. The version number is preferable to be assigned according to a “revision control system (RCS) rule”. When the material version 903 is omitted, it is regarded as the same as the configuration to which the attribute information 920 belongs. When more than one revision is present with the same material name in the configuration, only the latest revision is effective in the software build system 100.

The system type 904 specifies the type as any one of Regular, PMP (performance management pack), EmergencyFix (emergency fix pack), SoftLook (trial version), and Any. The operable OS 905 indicates an OS on which the material operates. The area 906 indicates a country or a region, to indicate the material is whether a domestic edition or an overseas edition. The material edition 907 specifies the edition (Standard, Enterprise, Personal, and Other) of the material.

The material format 908 indicates a format of a material, specifying one of Packed (compressed), Unpacked (not compressed), and Other. The last version 909 indicates based on which version the material is created. When omitted, it is regarded as the same as the last version of the configuration to which the material belongs.

The external name 910 describes a name and explanation that are easy for people to understand, such as meaning or purpose of the material, for example, “TWOffice V5.1 Japanese edition PMP0405”, “TWOffice V5.3 Japanese edition special correction 002 for Nippon Shinbun”, and the like. For example, regarding versions, the version used in the software build system 100 and the product version included in the above example are not the same, and therefore, describing this external name 910 is meaningful.

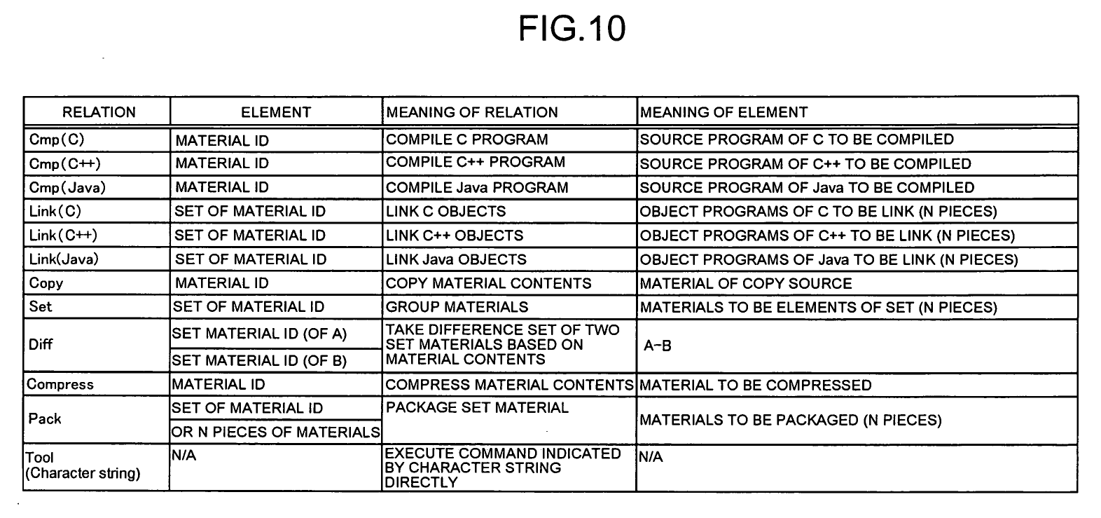

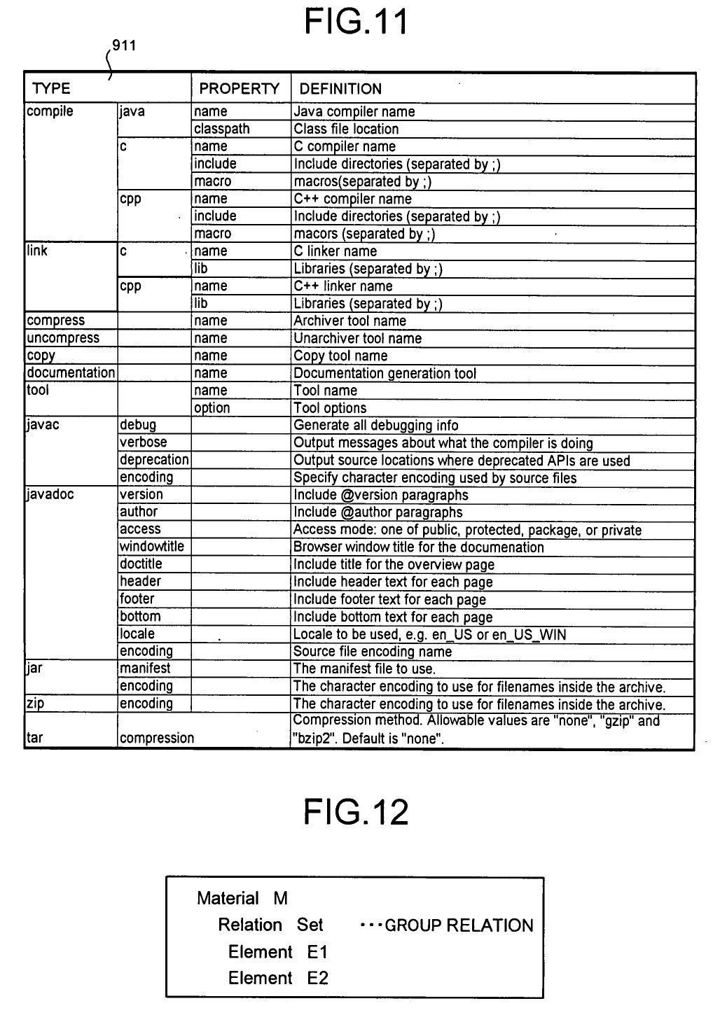

The relation 940 has a type 911, an element 912, and a D-Param 913. The relation 940 indicates a composite method of elements, and the type 911 indicates the type of the relation 940. FIG. 10 is a chart illustrating relativity between relation and an element. The D-Param describes an option of the type 911. FIG. 11 is a chart of the D-Param.

A target 914 shown in FIG. 9 indicates whether the material has a possibility to be provided to users. For example, a source program is usually “not-target”. An independent load module is usually “not-target” also. However, a set of load modules can be “target”.

Furthermore, a persistence 915 specifies whether material contents of the material are to be preserved. Intermediate materials obtained in the composing process, for example, an object program that is obtained as a result of compilation and the like, are usually set as “non-persistent”. Target materials should be “persistent”. The existence 916 indicates whether the material contents of the material already exist. Especially in the case of a composite material, the existence 916 indicates whether the material has already been composed or is to be composed. The integrator can control a partial building by appropriately resetting this parameter (existence 916) at the time of rebuilding. However, at rebuilding, creating a new configuration is the proper way of rebuilding and this parameter (existence 916) should not independently be changed.

The configuration definition entity of a software material is information that describes the configuration of a software material in the configuration definition language. The configuration definition language is a standardized description method of a configuration definition, and has strong points of enabling abstraction and being declarative language. Specifically, there are strong points as in (A) to (M) below.

(A) A single configuration definition can be used as both a material composing “program” and material configuration “data”.

(B) It is independent of an OS or a developing language.

(C) It is possible to define for each material. In the conventional techniques, a command string (in other words, a composing program) to perform a composing process has been described.

(D) All configurations can be defined by simple repetition of “material, relation, and element”. The “material” is to define an output material to be composed, the “relation” is to define a composite method, and the “element” is to define an element material group to be inputs in composing.

(E) As shown in FIG. 10, words (for example, compile) having high generality can be used for the “relation” name. In the conventional techniques, special terms that are dependent on the developing language have been used, and there have been problems in descriptability and readability.

(F) For example, it is possible to automatically determine whether each partial composing in a large-scale composing process is to be sequentially processed or to be parallel-processed. Reference to the divergence of a tree of the configuration definition enables the automatic determination.

(G) With the concepts of a single material and a set (i.e., group) material, a file material and a folder material can be equally handled. In other words, the materials can be handled without regard to being file or folder.

(H) With the concept of a set material, relation corresponding to a general set (grouping) operation (for example, a set (making into folders), a set sum, a set difference, a set product, and a set of sets) can be used. Thus, an operation that appears in an actual processing such as extraction of only a difference from last version can also be described as one “relation”.

(I) A set operation can be realized as “declarative” relation. This guarantees that each material always exists as statically defined by the configuration definition, as long as the material exists. FIG. 12 is a schematic for explaining a description example of the configuration definition. In FIG. 12, it is indicated that a file E1 and a file E2 are present under a folder M of a set material. When this configuration definition shown in FIG. 12 is to be executed, the set material is realized as the folder M on a file system.

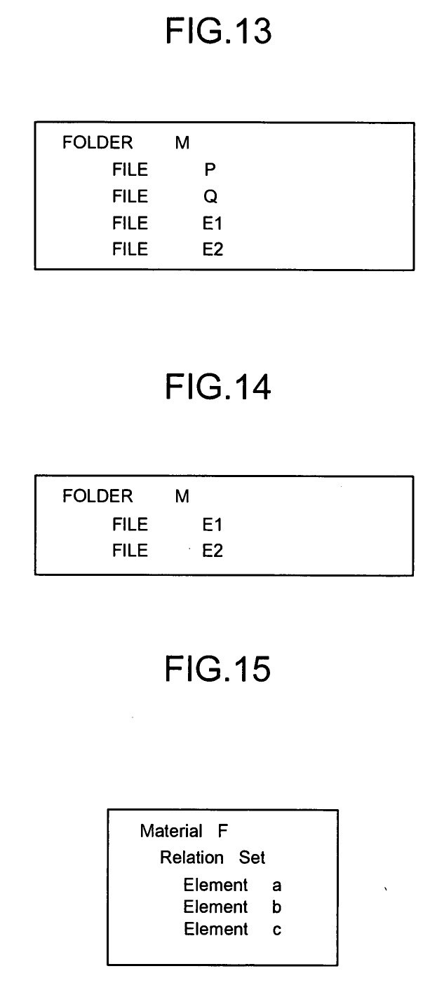

At this time, if some files, for example, a file P and a file Q already exist in the folder M, in the conventional method in which importance of the “declarativity of a configuration definition” is not recognized, this configuration definition is “procedurally” interpreted to be in the state shown in FIG. 13. FIG. 13 is a schematic illustrating a folder state after a configuration definition is executed in the conventional method. On the other hand, in the present invention, the state after execution of the configuration definition is to be the state shown in FIG. 14. FIG. 14 is a schematic illustrating a folder state after execution of the configuration definition according to the embodiment of the present invention. Specifically, the file P and the file Q that originally exist in the folder M are deleted.

(J) Pack relation that describes a complicated packaging operation by one word is prepared.

(K) Tool relation that enables free description of a composing operation that has not been standardized is prepared.

(L) A mechanism (the above described D-Param description shown in FIG. 11) to describe, in a localized manner, a platform dependency and a special parameter that cannot be transitionally abstracted or standardized is prepared.

(M) Various kinds of attributes other than composition relation can be defined for each material (for example, the persistence 915 and the target 914 shown in FIG. 9). These attributes have a “declarative” meaning, and therefore, can be used as one having multiple meanings in processing. For example, the persistence 915 (persistent attribute) merely indicates whether the completed material is to be persistently preserved. However, by positively using the “not-persistent (not-persistent attribute)”, a subroutine method in ordinary programming can also be introduced to the configuration definition.

Specifically, when definition of an intermediate material improves modularity and an outlook of the entire configuration definition, as long as the intermediate materials are specified as “not-persistent” in the persistence 915, no matter how large the number of the intermediate materials becomes, there is no influence on a final output result. Therefore, the readability of the entire configuration definition can be pursued. Moreover, the target 914 (target attribute) originally indicates whether the material is a material to be provided to customers (hereinafter, “customer providing material”). However, the target 914 can also be used to notify progress in a composing process, or can be used as a “unit of appropriate granularity” at the time of rebuilding because of failure.

The set operation has the concepts of the set (making into folders), the set sum, the set difference, the set product, the set of sets (meta set) as described above. FIG. 15 is a schematic for explaining an example of set. The set corresponds to defining a folder that is constituted of several files, and becomes a precondition of the set sum, the set difference, the set product, and the set of sets (meta set). For example, to define that “files a, b, and c exist under a folder F” in the build system, the configuration definition is described as shown in FIG. 15. If it is expressed with regular mathematical symbols, it is expressed as F={a, b, c}. Hereinafter, explanation is given using this notation.

The set sum is used, for example, for such an operation that file groups that are present in two folders are combined to one folder. Specifically, when there are the folder F={a, b, c} and a folder G={p, q}, a new folder that is constituted of these file groups can be created by using the set sum (expressed by “+”) as follows.

New folder: H=F+G={a,b,c,p,q}

The set difference is used, for example, when files that are modified from a last version and a corrected pack that is constituted only of the extracted files is created. Suppose that the last version is A={a1, b1, c1, d1, e1, f1} and a new version is B={a1, b2, c1, d1, e1, f2, g1}, where, numerals indicate the difference in contents of the identical file.

Therefore, the above description indicates that in the new version, contents of the file b and the file f are changed from the last version and a file g is newly added. In this case, by defining the corrected pack: C=B−A, a result shown below is obtained by following an arithmetic rule of a normal set difference, and contents of the corrected pack as expected can be obtained. Thus, the set difference is useful in an actual operation of creating a corrected pack.

$$\begin{matrix}C = B - A \\ = \{ a 1 , b 2 , c 1 , d 1 , e 1 , f 2 , g 1 \} - \{ a 1 , b 1 , c 1 , d 1 , e 1 , f 1 \} \\ = \{ b 2 , f 2 , g 1 \}\end{matrix}$$

The set product is used when only files common to two folders are extracted to form a new folder. Further, the set of sets (meta set) is used when folders are hierarchically arranged in multistage to form a customer providing material. This situation often occurs in practice. For example, when there are a folder A={a, b, c, F} and a folder F={d, e}, and a folder G having a file f as an element is to be created, it should be defined as G={A, F, f}. At this time the folder G is as follows.

G={A,F,f}={{a,b,c,{d,e}}, {d,e},f} where

G≠{a,b,C,d,e,f}, G≠{{a,b,c,{d,e},f}

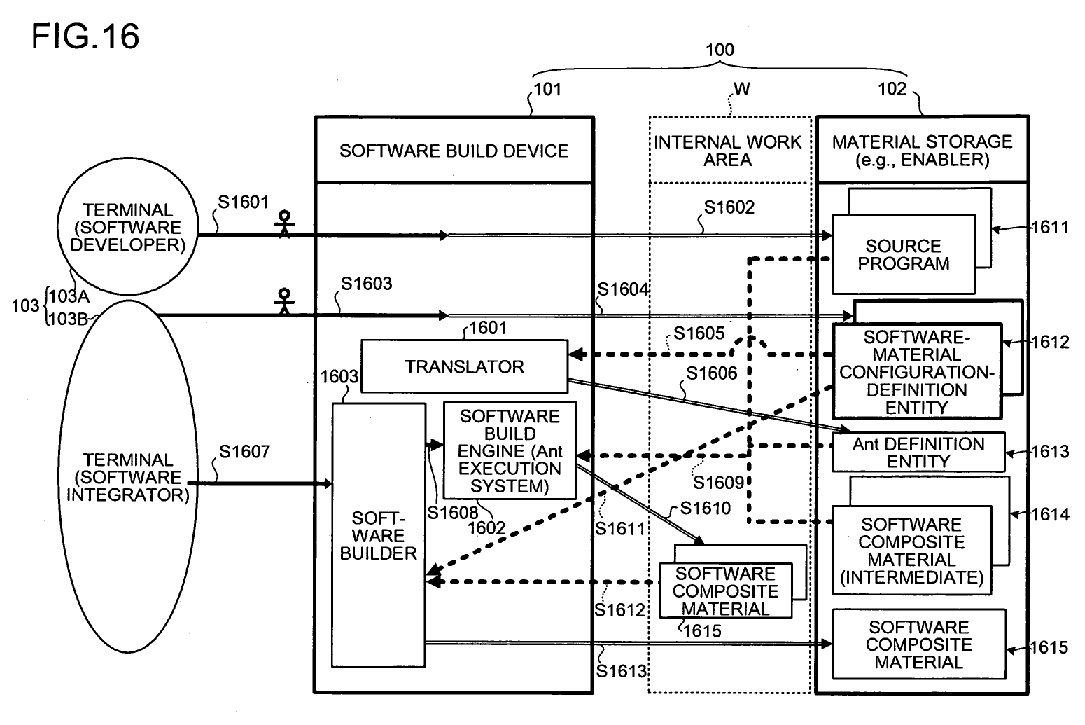

FIG. 16 is a block diagram of a system configuration of the build system according to the embodiment of the present invention. As shown in FIG. 16, the software build device 101 includes a translator 1601, a software build engine 1602, and a software builder 1603.

In the example shown in FIG. 16, Enabler is used as the material storage 102, and an Ant execution system is used as the software build engine 1602. Even when other systems (for example, a concurrent version system (CVS) as the material storage 102, and Makefile as the software build engine 1602) are used as the material storage 102 and the software build engine 1602, the implementation principle is the same. In FIG. 16, a solid line arrow represents instructing or calling, a dotted line arrow represents inputting or referring, and a double line arrow represents outputting or storing. A stick figure on an arrow indicates that an operation by a human is involved.

As shown in FIG. 16, each software developer creates or updates the contents of a source program with a terminal 103A and gives instruction for the storage of the resulting source program (step S1601). The software build device 101 stores a source program 1611 in the material storage 102 (step S1602).

Subsequently, a software integrator describes a configuration of each software material in the configuration definition language with a terminal 103B (the description thus obtained is referred to as “software-material configuration-definition entity”), and instructs the software build device 101 to register the software-material configuration-definition entity (step S1603). The software build device 101 stores the software-material configuration-definition entity 1612 in the material storage 102 (step S1604).

When the software-material configuration-definition entity 1612 is registered in the material storage 102, the software build device 101, using the translator 1601, interprets and translates the software-material configuration-definition entity 1612 into a definition entity that is described in the Ant language (hereinafter, Ant definition entity 1613) (step S1605). This Ant definition entity 1613 is also stored in the material storage 102 (step S1606).

When an instruction to build a software material is input from the terminal 103B of the software integrator, in other words, when a material ID (see FIG. 9) of the software material to be built is specified (step S1607), the software builder 1603 of the software build device 101 secures an internal work area W to prepare an operating environment for the Ant execution system 1602, and activates the Ant execution system 1602 (step S1608).

The Ant execution system 1602 is input with the Ant definition entity 1613 that corresponds to the material indicated by the material ID specified at step S1607. At this time, the source program 1611 and other software composite materials 1614 that are stored in the material storage 102 are also input into the Ant execution system 1602 (step S1609). The Ant execution system 1602, according to the Ant definition entity 1613, performs a software build process using the source program 1611 and other software composite materials 1614. A software composite material 1615 obtained as a result of a material building by the Ant execution system 1602 (a composite material or output) is stored in the internal work area W as an intermediate product (step S1610).

The software builder 1603 refers to the attribute information 920 of each material that is described in the software-material configuration-definition entity 1612 (step S1611), reads each of the software composite materials 1615 in the internal work area W (step S1612), and writes back into the material storage 102 each of the software composite materials 1615 (step S1613).

A control is also performed at this time such that, among the composite material existing as a new composite material in the internal work area W, only the composite material that has the attribute information indicative of “yes” for the persistence 915 is stored in the material storage 102. Thereafter, the software build device 101 performs post-processing such as deletion of the internal work area W, thereby eliminating the need for a user (integrator) of the software build device 101 to be concerned with the internal processing or the intermediate products (the software composite material 1615) of the software build device 101.

The translator 1601 converts the software-material configuration-definition entity 1612 into the Ant definition entity 1613. The software-material configuration-definition entity 1612 is described in the configuration definition language according to an extensible markup language (XML) format. The Ant definition entity 1613 is described in the grammar of Ant, which is a freeware. The translator 1601 is a kind of complier that converts description formats and therefore, similar to a common compiler, there can be various implementation-methods thereof. The most appropriate implementation method is to form the desirable translator 1601 by inputting rules of conversion from the original description to the interpreted description in a compiler.

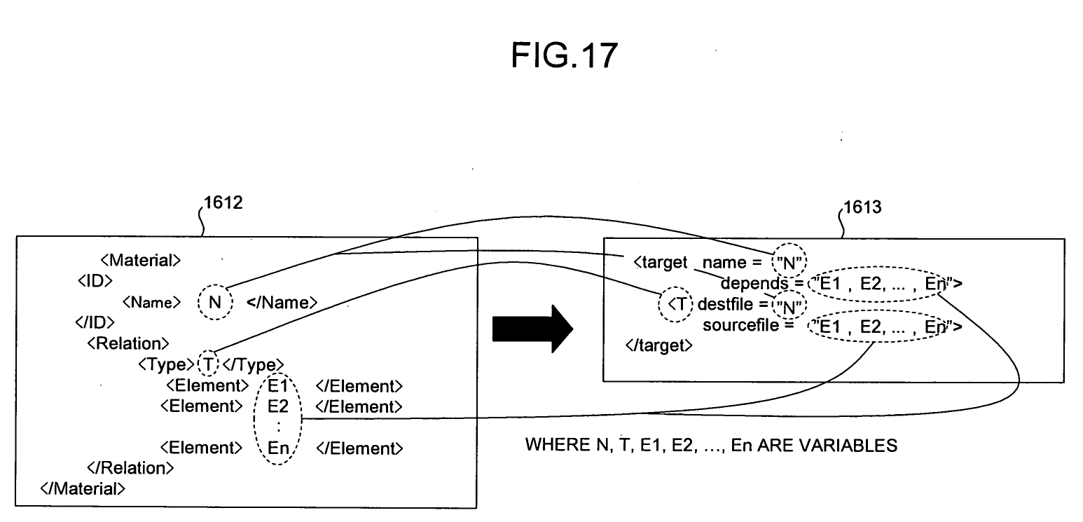

The conversion from the software-material configuration-definition entity 1612 to the Ant definition entity 1613 can be performed according to the following conversion rules basically. FIG. 17 is a schematic for explaining the interpretation from the software-material configuration-definition entity to the Ant definition entity. A material name “N” in the software-material configuration-definition entity 1612 is changed to a target name in the Ant definition entity 1613.

A task name “T” of the software-material configuration-definition entity 1612 is a kind of command (“destfile” in FIG. 17) called “task” in the Ant definition entity 1613. For example, “compile” is a command meaning to compile. Tasks that are not prepared in the Ant definition entity 1613 as a standard can be separately defined as original tasks. The elements E1 to En of the software-material configuration-definition entity 1612 are defined as “depends” and “sourcefile” in the Ant definition entity 1613.

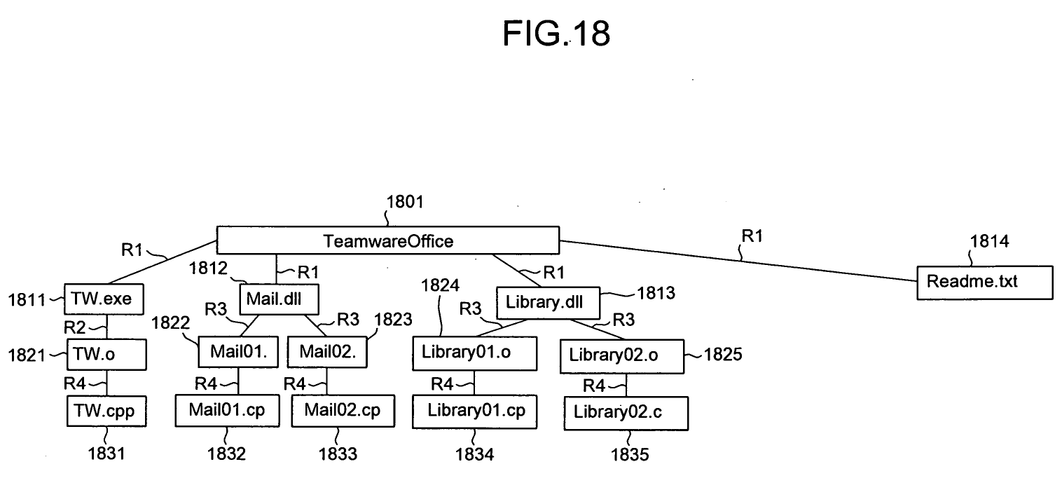

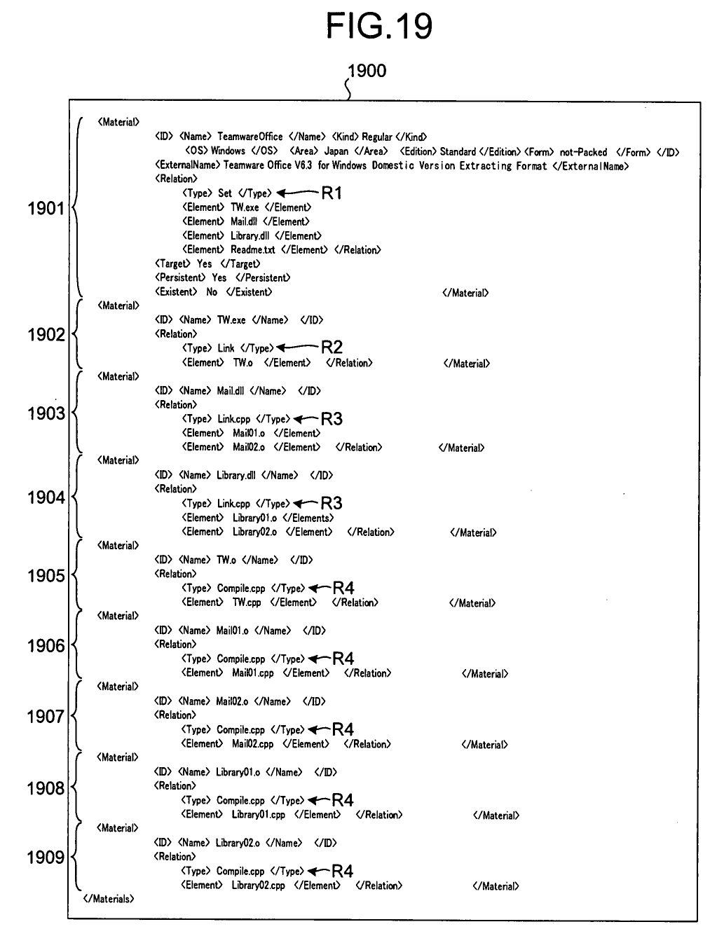

FIG. 18 is a schematic of a tree configuration of a customer providing material, and FIG. 19 is a schematic illustrating a description example of the software-material configuration-definition entity of the customer providing material shown in FIG. 18.

In the example shown in FIG. 18, this customer providing material (configuration name: TeamwareOffice) 1801 has a material (material name: TW.exe) 1811, a material (material name: Mail.dll) 1812, a material (material name: Library.dll) 1813, and a material (material name: Readme.txt) 1814 as elements in a relation R1 meaning set. The configuration of the material 1801 is defined by description information 1901 of a software-material configuration-definition entity 1900 shown in FIG. 19.

Furthermore, the material 1811 has a material (material name: TW.o) 1821 as an element in a relation R2 of link (Link). The configuration of the material 1811 is defined description information 1902 of software-material configuration-definition entity 1900 shown in FIG. 19.

The material 1812 has a material (material name: Mail01.) 1822 and a material (material name: Mail02.) 1823 as elements in a relation R3 of link (Link.cpp). The configuration of the material 1812 is defined by description information 1903 of the software-material configuration-definition entity 1900 shown in FIG. 19.

The material 1813 has a material (material name: Library01.o) 1824 and a material (material name: Library02.o) 1825 as elements in the relation R3 of link (Link.cpp). The configuration of the material 1813 is defined by description information 1904 of the software-material configuration-definition entity 1900 shown in FIG. 19.

The material (material name: TW.o) 1821 has a material (material name: TW.cpp) 1831 to be a source file as an element in a relation R4 of compilation (compile.cpp). The configuration of the material 1821 is defined by description information 1905 of the software-material configuration-definition entity 1900 shown in FIG. 19.

The material 1822 has a material (material name: Mail01.cp) 1832 to be a source file as an element in the relation R4 of compilation (compile.cpp). The configuration of the material 1822 is defined by description information 1906 of the software-material configuration-definition entity 1900 shown in FIG. 19.

The material 1823 has a material (material name: mail02.cp) 1833 to be a source file as an element in the relation R4 of compilation (compile.cpp). The configuration of the material 1823 is defined by description information 1907 of the software-material configuration-definition entity 1900 shown in FIG. 19.

The material 1824 has a material (material name: Library01.cp) 1834 to be a source file as an element in the relation R4 of compilation (compile.cpp). The configuration of the material 1824 is defined by description information 1908 of the software-material configuration-definition entity 1900 shown in FIG. 19.

The material 1825 has a material (material name: Library02.cp) 1835 to be a source file as an element in the relation R4 of compilation (compile.cpp). The configuration of the material 1825 is defined by description information 1909 of the software-material configuration-definition entity 1900 shown in FIG. 19. In other words, the materials 1811 to 1813 are respectively created by compiling or link editing source files such as the elements 1831 to 1835.

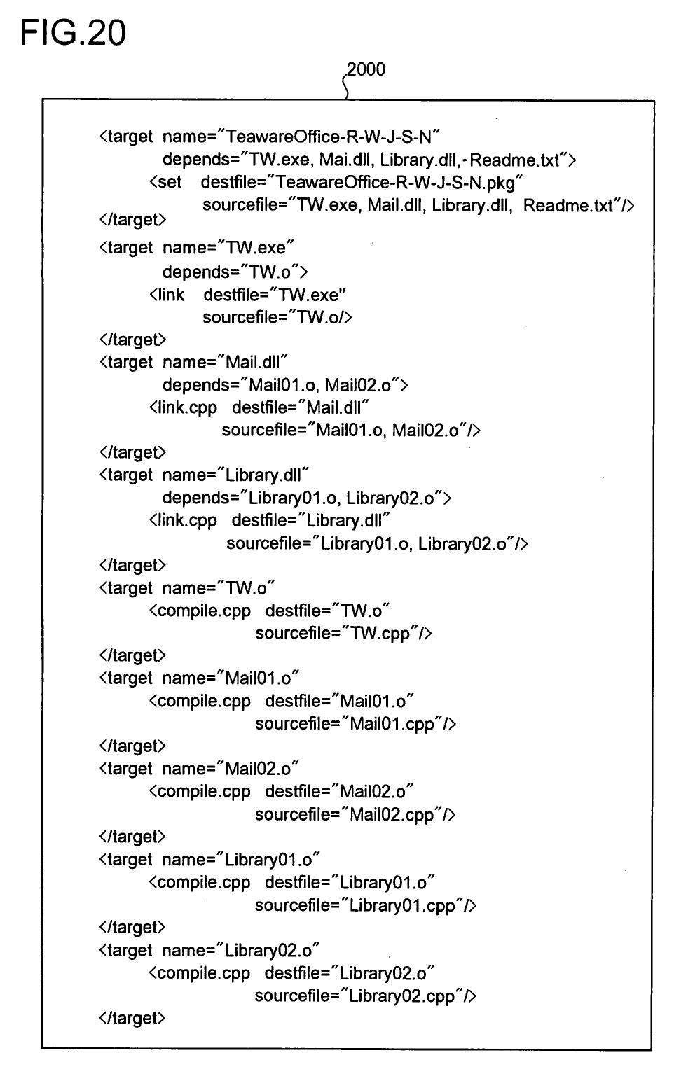

FIG. 20 is a schematic of the Ant definition entity that is converted from the software-material configuration-definition entity 1900 shown in FIG. 19. An Ant definition entity 2000 is an electronic document in the XML format that is translated from the software-material configuration-definition entity 1900 by the translator 1601.

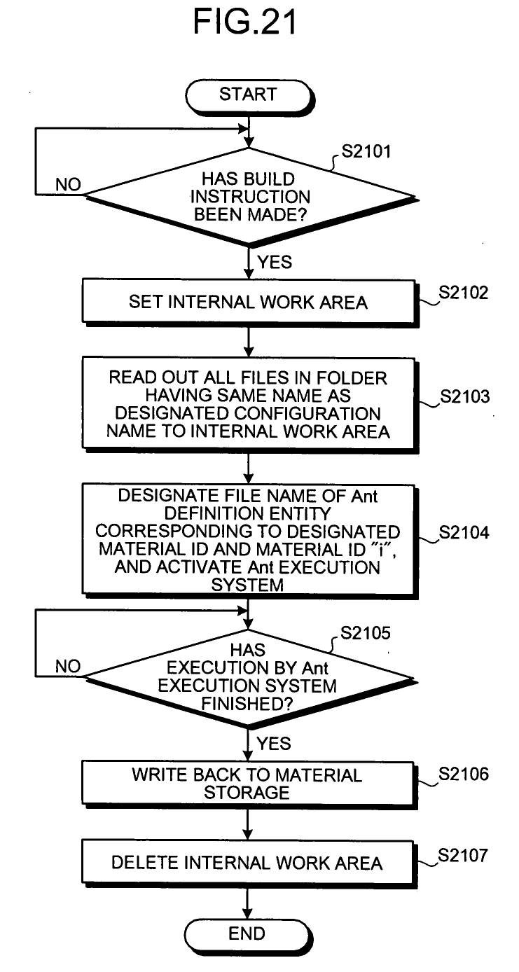

FIG. 21 is a flowchart of a software build process performed by the software builder 1603 shown in FIG. 16. As shown in FIG. 21, first, when a build instruction with designation of configuration name “c” and material ID “i” is input (step S2101: YES), the internal work area W for the Ant execution is set (step S2102).

Subsequently, all files in a folder “c” having the same name as the designated configuration name “c” are read out from the material storage 102 to the internal work area W (step S2103). A configuration name to be designated corresponds to a folder name in the material storage 102. Further, at this time, a check-out process is performed at the material storage 102.

The Ant execution system 1602 is activated upon designation of the material ID “i” and a file name of the Ant definition entity 1613 corresponding to the designated material ID “i” (step S2104). The Ant definition entity 1613 corresponding to the designated material ID “i” also exists in the internal work area W as one of the files read therein. The file name of the Ant definition entity 1613 is “c.xml”. The material ID “i” coincides with the target name in the Ant definition entity 1613.

In the Ant execution system 1602, a specific target in the designated Ant definition entity 1613 is executed. The target name to be executed can be identified by the material ID that is designated by the caller program, i.e., the software builder 1603. Composite materials created during processing by the Ant execution system 1602 are stored in the internal work area W.

When the processing by the Ant execution system 1602 is finished (step S2105: YES), based on a software-material configuration-definition entity “c.attr”, a composite material whose attribute information of the persistence 915 is yes, among the materials (files and folders) that are present in the internal work area W, is written back to the material storage 102 (step S2106). A check-in process is then performed at the material storage 102. Finally, the internal work area W of the Ant execution system 1602 is deleted (step S2107).

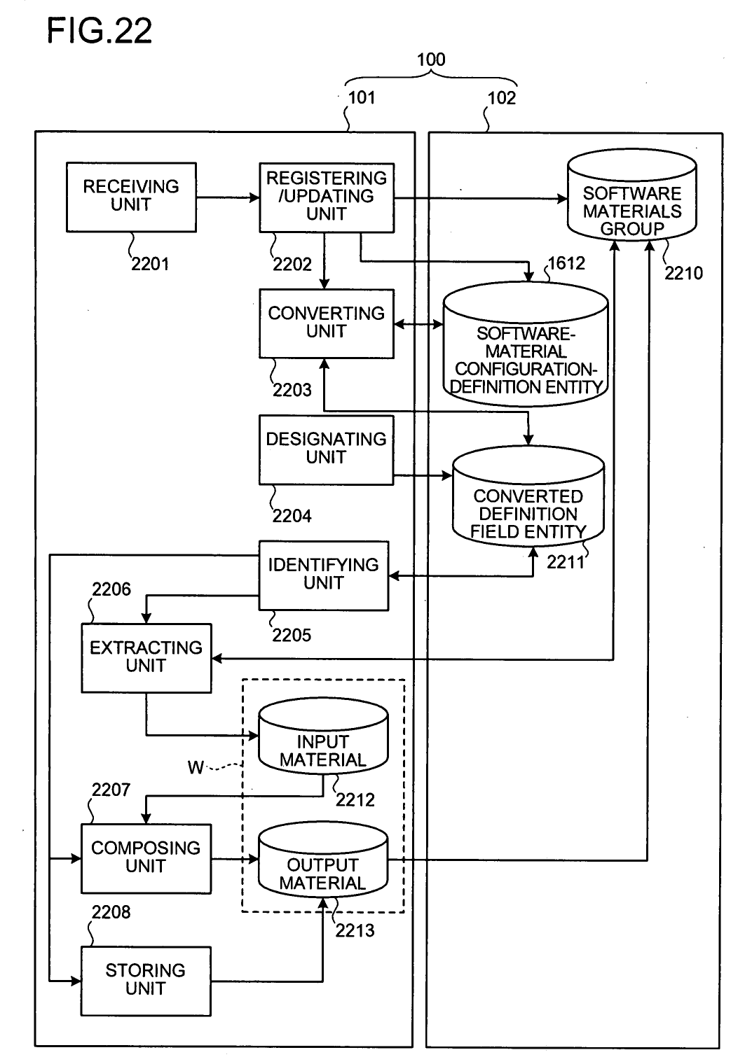

FIG. 22 is a block diagram of a functional configuration of the software build system according to the embodiment of the present invention. Like reference characters are given to like components as those shown in FIG. 1 and FIG. 16, and explanation thereof is omitted. As shown in FIG. 22, the software build device 101 includes a receiving unit 2201, a registering/updating unit 2202, a converting unit 2203, a designating unit 2204, an identifying unit 2205, an extracting unit 2206, a composing unit 2207, and a storing unit 2208.

The receiving unit 2201 receives an input of a software material such as a source code that is created or updated with the terminal 103 by an operation of a developer, or a software-material configuration-definition entity 1612 (for example, the software-material configuration-definition entity 1900 shown in FIG. 19). The receiving unit 2201 receives an input as the software-material configuration-definition entity 1612.

The software-material configuration-definition entity 1612 is an electronic document that defines the configuration of the software material to be the composite output (hereinafter, “output material”) by identification information of the output material, identification information of the software material(s) to be the composing input (hereinafter, “input materials” however, not imparting limitation to the plural) and identification information of a composite method of using the input materials to generate the output material. The software-material configuration-definition entity 1612 is described, for example, in the XML format.

The input materials are source software materials of the output material, in other words, elements. The composite method indicates the relation between the output material and the input materials, and for example, is the type 911 such as compilation, link, and compression shown in FIG. 11. With reference to FIG. 18, when the output material is the material 1801, the input materials are the materials 1811 to 1814, and the composite method is the relation R1 representing set.

The identification information of an output material is the configuration name 901 or the material name 902 that is described in the material ID 930. With reference to FIG. 18, when the output material is 1801, the identification information of the material 1801 is the configuration name: TeamwareOffice of the material 1801. When the output material is the material 1811, the identification information of the material 1811 is the material name (material name: TW.o) of the material 1811.

The identification information of a composite method is the type 911 of the relation 940. With reference to FIG. 18, when the output material is the material 1801, the input materials are the materials 1811 to 1814, and the composite method is the relation R1 representing set.

The registering/updating unit 2202 writes, in the material storage 102, a software material, an input of which is received. The software materials 2210 are a set of software materials such as a source file(s) thus written and the software composite material 1614 that is composed by the composing unit 2207 described later. The functions of the receiving unit 2201 and the registering/updating unit 2202 are implemented, for example, by executing a program that is recorded on a recording medium such as the ROM 202, the RAM 203, and the HD 205 shown in FIG. 2 by the CPU 201, or by the I/F 209.

When the software-material configuration-definition entity 1612 is registered by the registering/updating unit 2202, the converting unit 2203 converts the software-material configuration-definition entity 1612 into a definition entity (hereinafter, “converted definition entity 2211”) having a description format that can be interpreted by the composing unit 2207 described later. When the composing unit 2207 i's, for example, the Ant execution system 1602 shown in FIG. 16, the software-material configuration-definition entity 1612 is converted into the Ant definition entity 1613 as the converted definition entity 2211. The converting unit 2203 specifically corresponds to the translator 1601 shown in FIG. 16, and more specifically, the function thereof is implemented by executing a program recorded on a recording medium such as the ROM 202, the RAM 203, and the HD 205 shown in FIG. 2 by the CPU 201.

The designating unit 2204 receives designation of the identification information of an arbitrary software material. Specifically, the designating unit 2204 receives designation of the configuration name 901 or the material name 902 that is described in the material ID 930 of a software material to be built. Specifically, the function of this designating unit 2204 is implemented by, for example, the I/F 209 shown in FIG. 2.

The identifying unit 2205 identifies the identification information of both the composite method and the input materials based on the software-material configuration-definition entity 1612 (i.e., the converted definition entity 2211) and the software material whose identification information is designated as the output material by the designating unit 2204. With reference to FIG. 18, when the software material that is designated by the designating unit 2204 is the material 1801, the material 1801 is to be the output material, and the software materials 1811 to 1814 being the elements of the material 1801 are to be the input materials. Therefore, the material IDs (material names: TW.exe, Mail.dll, Library.dll, Readme.txt) of the software materials 1811 to 1814 are identified as the identification information of the input materials, and the identification information (type: set) of the relation R1 is identified as the identification information of the composite method.

The identifying unit 2205 newly sets, as an output material, the input materials whose identification information is identified, and identifies the identification information of the input materials to be a composing input of the new output material and the identification information of the composite method. With reference to FIG. 18, while in the above example, the software materials 1811 to 1814 are the input materials, the software materials 1811 to 1814 are newly set as the output materials, and the identification information of new input materials to be composing input of the software materials 1811 to 1814 is identified.

In this case, the software material 1821 is the new input material for the software material 1811, the software materials 1822 and 1823 are the new input materials for the software material 1812, and the software materials 1824 and 1825 are the new input materials for the software material 1813. The software material 1814 is merely a text document and has no input material to be a child.

Thus, the identifying unit 2205 continues identification of the identification information of the input materials and the identification information of the composite method until input materials to be a child are exhausted. The function of the identifying unit 2205 is implemented, for example, by executing a program that is recorded on a recording medium such as the ROM 202, the RAM 203, and the HD 205 shown in FIG. 2 by the CPU 201.

The extracting unit 2206 extracts an input material 2212 whose identification information is identified or newly identified by the identifying unit 2205 from the software materials 2210 stored in the material storage 102. Specifically, the extracting unit 2206 extracts a software material such as a source material to be the input material 2212 based on the identification information. The extracted input material 2212 is stored in the internal work area W.

The identifying unit 2205 specifically is a function of the software build engine (Ant execution system) 1602 shown in FIG. 16, and more specifically, the function thereof is implemented by executing a program recorded on a recording medium such as the ROM 202, the RAM 203, and the HD 205 shown in FIG. 2 by the CPU 201.

The composing unit 2207 composes the input materials that are extracted by the extracting unit 2206 to output the output material 2213 based on the composite method whose identification information is identified by the identifying unit 2205. The output material 2213 is stored in the internal work area W as an intermediate product. The composing unit 2207 can execute the composite method (compilation, link, compression, etc.) that is defined by the type 911 shown in FIG. 11.

The composing unit 2207 specifically is a function of the software build engine (Ant execution system) 1602 shown in FIG. 16, and can execute the above composite method by interpreting the Ant definition entity 1613. The function of the composing unit 2207 is implemented, for example, by executing a program recorded on a recording medium such as the ROM 202, the RAM 203, and the HD 205 shown in FIG. 2 by the CPU 201.

When the attribute information concerning the persistence 915 of the output material is described in the software-material configuration-definition entity 1612, the storing unit 2208 stores in the material storage 102 the output material that is composed by the composing unit 2207. Specifically, when the attribute information concerning the persistence 915 of the output material is “yes” (or “persistent”), the storing unit 2208 writes the composed output material in the material storage 102 from the internal work area W.

The storing unit 2208 specifically corresponds to the software builder 1603 shown in FIG. 16, and more specifically, the function thereof is implemented, for example, by executing a program recorded on a recording medium such as the ROM 202, the RAM 203, and the HD 205 shown in FIG. 2 by the CPU 201.

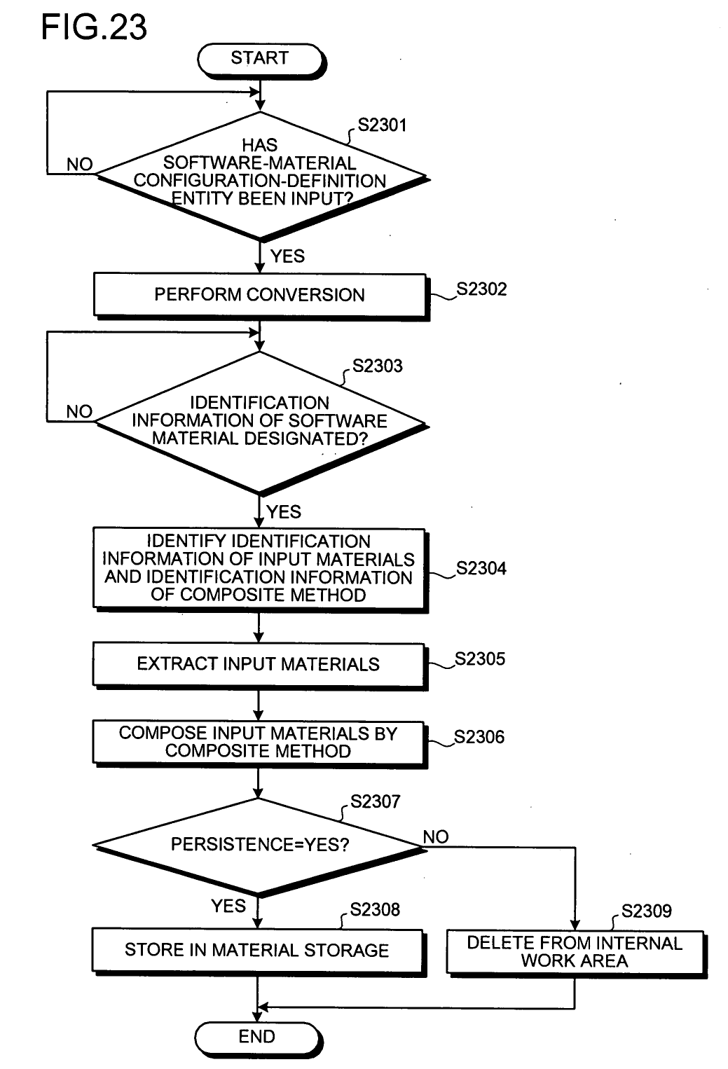

FIG. 23 is a flowchart of a software build process by the software build system according to the embodiment of the present invention. As shown in FIG. 23, when the software-material configuration-definition entity 1612 is received by the receiving unit 2201 (step S2301: YES), the conversion is performed by the converting unit 2203, in other words, the software-material configuration-definition entity 1612 is converted into the converted definition entity 2211 (step S2302).

When the designating unit 2204 receives designation of the identification information (material ID 930) of any software material (step S2303: YES), the identifying unit 2205 sets, as an output material, the software material whose identification information is designated, and identifies the identification information of input materials to be composing input of the output material and the identification information of the composite method (step S2304).

Subsequently, the extracting unit 2206 extracts the input materials 2212 whose identification information is identified by the identifying unit 2205 from the software materials 2210 in the material storage 102 (step S2305). Thereafter, the composing unit 2207 composes the input materials 2212 by the composite method whose identification information is identified by the identifying unit 2205, to output the output material 2213 (step S2306).

When the attribute information of the persistence 915 of the software-material configuration-definition entity 1612 is “yes” (step S2307: YES), the storing unit 2208 writes the output material 2213 that is composed and output, in the material storage 102 (step S2308). On the other hand, when the attribute information of the persistence 915 is “no” (step S2307: NO), the output material 2213 that is composed and output is deleted from the internal work area W (step S2309).

According to this software build processing, when the identification information (material ID 930) designated by the designating unit 2204 is the configuration name 901, software (customer providing material) that is desired to be built can finally be automatically built merely by the operation of inputting designation of the material ID. Particularly, when an input material to be a composing input of an output material further has a child to be a new input material, the composite method can be identified for each new input material by referring to the software-material configuration-definition entity 1612 (converted configuration field 2211).

Therefore, the composing unit 2207 can perform the composing processing by multiple composite methods in parallel, thereby shortening the software build processing time. In addition, the output material 2213 that does not need to be stored can automatically be deleted without writing in the material storage 102, thereby preventing the storage of unnecessary software materials and saving memory capacity.

As described above, the software build program, the recording medium that stores the program, the software build method, and the software build system according to the embodiment of the present invention exert the following effects (1) to (4).

(1) Complicated software build work is almost completely automated. Therefore, compared to existing software build systems, credibility and reproduction potential are improved.

(2) The software building work is almost completely automated. Therefore, compared to existing software build systems, the work load on a builder is significantly reduced.

(3) The software configuration definition language has high abstractiveness and high declarativity. Therefore, compared to the existing configuration definition language (for example, Makefile language and Ant language), the readability of the configuration definition of software is greatly improved, thereby improving the credibility.

(4) Tracking of configuration relations of software in a wide range that has been done by human intelligence and human hand, warning of a problem and the like can be automatically performed, thereby improving productivity and credibility.

The software build method explained in the present embodiment can be implemented by a computer such as a personal computer and a workstation executing a program that is prepared in advance. This program is recorded on a computer-readable recording medium such as a hard disk, a flexible disk, a CD-ROM, an MO, and a DVD, and is executed by being read out from the recording medium by a computer. This program can be a transmission medium that can be distributed through a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a software build program that causes a computer to execute:
receiving a designation of a first identification information indicative of an output material that is a composite of a plurality of input materials;
identifying, based on a configuration-definition entity, a second identification information indicative of each of the input materials, and a third identification information indicative of a composite method of composing the input materials to generate the output material;
extracting the input materials from a material storage based on the second identification information; and
composing the input materials based on the third identification information.

2. The software build program according to claim 1, further causing the computer to execute converting the configuration-definition entity into a configuration-definition entity with a predetermined format, wherein
the identifying includes identifying the second identification information and the third identification information based on the configuration-definition entity with the predetermined format.

3. A software build method comprising:
receiving a designation of a first identification information indicative of an output material that is a composite of a plurality of input materials;
identifying, based on a configuration-definition entity, a second identification information indicative of each of the input materials, and a third identification information indicative of a composite method of composing the input materials to generate the output material;
extracting the input materials from a material storage based on the second identification information; and
composing the input materials based on the third identification information.

4. A software build system comprising:
a storage unit that stores a plurality of input materials and a configuration-definition entity that defines a configuration of an output material that is a composite of the input materials;
a receiving unit that receives a designation of a first identification information indicative of the output material;
an identifying unit that identifies, based on the configuration-definition entity, a second identification information indicative of each of the input materials, and a third identification information indicative of a composite method of composing the input materials to generate the output material;
an extracting unit that extracts the input materials from the storage unit based on the second identification information; and
a composing unit that composes the input materials based on the third identification information.

5. The software build system according to claim 1, further comprising a converting unit that converts the configuration-definition entity into a configuration-definition entity with a predetermined format, wherein
the identifying unit identifies the second identification information and the third identification information based on the configuration-definition entity with the predetermined format.
